(19) United States
(12) Patent Application Publication
(10) Pub. No.: US 2014/0233221 A1
(43) Pub. Date: Aug. 21, 2014

(54) Single Maneuver Setup Standalone Unit Umbrella Artificial Tree

(71) Applicant: Cheng-che Tsai, Hong Kong (CN)

(72) Inventor: Cheng-che Tsai, Hong Kong (CN)

(21) Appl. No.: 13/770,681

(22) Filed: Feb. 19, 2013

(51) Int. Cl. A47G 33/06; F21V 33/00

(52) U.S. Cl. CPC A47G 33/06; F21V 33/00
USPC 362/123; 428/9

(57) ABSTRACT

An umbrella Christmas tree comprising a slide ring, legs pivotably connected to the slide ring and branches rotationally connected to the legs is described. The tree is able to be transformed from a storage position into a continuum of display positions in one motion by sliding a slide ring along the tree trunk, while the legs extend outward increasing the in radius of the base of the tree. Likewise, the transition from a display position to a storage position is accomplished by moving the slide ring in the opposite direction along the tree trunk. These transitions resemble umbrella-like movement. The umbrella tree is pre-embellished with various decorations, including lights and other ornaments, as can be the components of the tree, obviating the need to decorate the tree after it has been set up. The one slide ring design simplifies assembly and disassembly and gives the umbrella tree a neater appearance.

### FIELD OF THE INVENTION

The present invention relates to artificial plants, and more particularly to collapsible artificial Christmas trees.

### BACKGROUND OF THE INVENTION

Every year around the world, Christmas trees are displayed to celebrate the holiday season. Christmas trees come in all shapes and sizes, and they are typically decorated with lights and various ornaments. They are displayed in homes as well as in offices, stores, and outside on public sidewalks and streets. This tradition began with using natural trees. Over time, artificial trees started being used more often because of their convenience and safety, and also because they can be used more than once. In particular, artificial trees do not shed as much, and they are easier to put up and take down. Therefore, what is needed in the art is a tree that can be easily assembled and disassembled. Generally, artificial trees are comprised of disparate trunk and branch segments, which are assembled separately. For example, a person will assemble, one-by-one, each of the trunk segments and then place each of a multitude of individual tree branches into the trunk segments. Generally, there are between 3-4 branches segments and 6 or more disparate branch pieces, as well as other ancillary pieces such as lock pins and stands. After that, the tree is decorated by adding lights and other ornaments, which are also separate items from the tree itself. Thus, the assembler has to spend time connecting each of these items while assembling the tree, and has to spend the same amount of time disconnecting the items when taking the tree down. This is cumbersome. Also, it is easy for the various components to be lost. For example, if any one of the trunk segments is lost, then the entire tree cannot be assembled. What is needed, therefore, is an artificial tree that is built together as one unit, in one piece, and that can be easily assembled and disassembled. A tree of this kind will also contain all of the advantageous features of general artificial trees, including safety. In an ideal world, a person would have access to a standalone tree that assembles and disassembles in one motion in the same way an umbrella opens and closes, which is the object of the present invention. There are several patents that attempt to address the aforementioned needs, none of which contain the unique advantages of the present invention. U.S. Pat. No. 4,847,123 to Armstead et al. describes a pop-up artificial Christmas tree, which may be collapsed into a storage state and erected so that the pop-up artificial Christmas tree is in a natural tree posture. However, this invention comprises a number of sleeves 36 in addition to a guide sleeve 40, as well as other detachable parts such as a hold pin. Also, the stand in Armstead et al. is assembled separately from the tree itself It does not describe a tree with inseparable components which can transform from a storage position to a display position in one motion like the way an umbrella opens and closes. U.S. Pat. No. 5,106,661 to Pitts discloses a compressible Christmas tree, comprising a stand, and multiple slidably mounted branch units held in spaced relation to one another by biasing means. The biasing means of a preferred embodiment are springs disposed between adjacent branch units. It does not describe a tree comprising only one tree unit comprising a slide ring to which legs are pivotably attached, where the tree is transformed into display or storage position in one motion. U.S. Pat. No. 6,334,694 to Huang describes a collapsible tree comprising various disparate components including a circular support, a combinable post and a small top ring among other disparate components. It does not contain the advantages of the present invention, namely a standalone umbrella tree unit which can be transformed into storage or display positions in one motion. U.S. Pat. No. 6,773,134 to Harvey describes an illuminated artificial tree having a display position and a folded position constructed of an odd number of upright wire mesh panels hingedly attached at their vertical inner edges, the panels including a first end panel, a second end panel and a plurality of intermediate panels between the first and second end panels. The tree in Harvey folds into its folded position much like a fan would. However, it does not describe a standalone unit umbrella tree that can be transformed into either a display position or storage position in one motion resembling an umbrella. In particular, when the tree is to be stored, panels 12 and 28 are detached and all panels are folded together in an abutting parallel relationship. U.S. Pat. No. 7,267,852 to Rosado et al. describes a collapsible artificial Christmas tree comprising a spring driven set of nestable branches and a plurality of slide rings. It does not describe a single unit umbrella tree with one slide ring used to transform the tree into display or storage position in one maneuver.

### SUMMARY OF THE INVENTION

The present invention relates to an artificial Christmas tree that can be transformed into a display or storage position in one motion, similar to the way an umbrella opens and closes. When the tree is in either a storage or display position, it is secured to the trunk by locking a slide ring at a position on the trunk. However, locking the tree is optional, since the tree must merely be stable in any of its positions. The tree is covered with wiring, layered at various distances along the length/height of the tree, where the wiring surrounds a cross-section of the tree. The wiring contains a plurality of light bulbs. The wiring, along with the light bulbs, remains on the tree when transforming the tree from the storage to display position, and vice versa. The umbrella Christmas tree has a slide ring, to which a plurality of legs are pivotably attached, such that when the slide ring is unlocked and pushed downward, the legs extend outward forming a stand supporting the tree in an upright position. While the legs serve to support the tree in an upright display position, the legs can also support the tree upright when in a storage position. The tree branches are rotationally connected to the legs of the tree, such that when the slide ring is pushed downward, they too extend outward forming the body of the tree. The branches are pivotably attached to a circular branch holder near the top of the tree. The tree resembles a cone, although a cross-section of the tree would be a polygon corresponding to the number of branches and legs. For example, if the tree has six branches and six corresponding legs, the cross section of the tree body would be a hexagon. If the tree has eight branches and eight corresponding legs, the cross section of the tree body would be an octagon. The tree can be used year after year and is portable, and can fit into a much smaller box than other artificial trees currently on the market. Many display positions are possible, as a tree of various girths can be displayed by simply moving the slide ring along the trunk.

The invention offers the advantage of having only one slide ring, used to transform the tree from its storage position to a display position and vice versa. Having only one slide ring immensely simplifies assembling and disassembling the tree, while given the tree a cleaner appearance. These same advantages are present due to all of the tree's components being attached in one standalone unit. Although the tree is intended to be used during Christmas, its features are such that it can be displayed all year round with the same effect.

### BRIEF DESCRIPTION OF THE DRAWINGS

FIG. 1 is a view of an umbrella Christmas tree in a storage position.

FIG. 2 is a view of the umbrella Christmas tree in a storage position and illuminated.

FIG. 3 is a view of the umbrella Christmas tree in a display position and illuminated.

FIG. 4 is a close-up view of the top of the umbrella Christmas tree.

FIG. 5 is a close-up view of the bottom of the umbrella Christmas tree when illuminated.

FIG. 6 is a close-up view of a slide ring, legs and trunk of the umbrella Christmas tree.

FIG. 7 is a close-up view of a leg rotationally attached to a branch.

FIGS. 8a-d demonstrate the process of transforming the tree from a storage position to a display position.

FIG. 9 is an example outdoor tree stand.

FIG. 10 is an example indoor tree stand.

### DETAILED DESCRIPTION OF THE PREFERRED EMBODIMENTS

The present invention is directed to an artificial tree which transforms between its storage and display positions in an umbrella-like fashion. In order to open an umbrella, a slide ring is typically pushed upwards. Here, the umbrella tree contains a slide ring that is maneuvered downwards to open the tree into a display position. Conversely, the slide ring is maneuvered upwards in order to transform the tree into a storage position. All of the components of the umbrella tree are connected, such that in order to store or transport the tree, no components need to be removed or unattached from each other. Accordingly, no individual tree components are lost and the umbrella tree is very convenient to set up and put away.

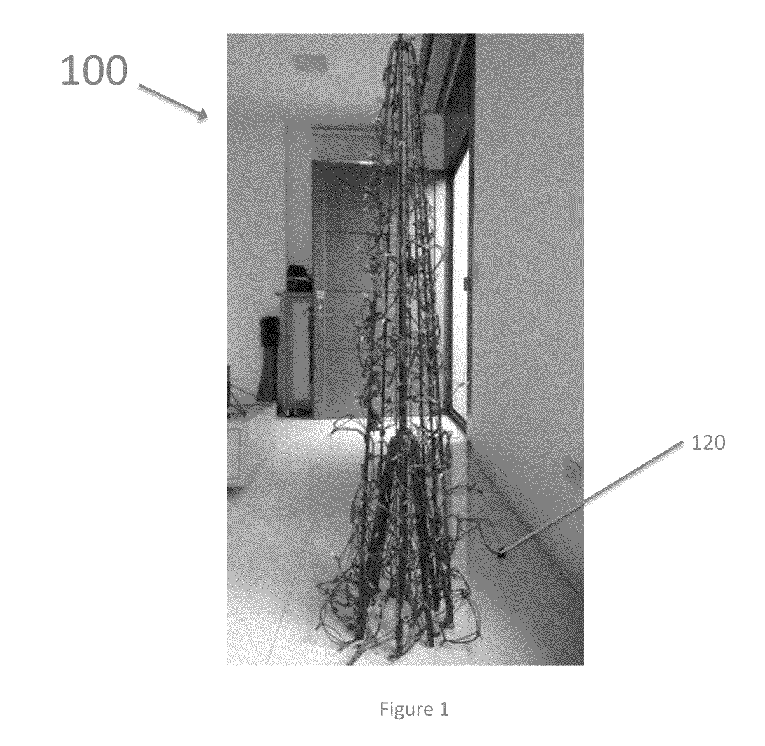

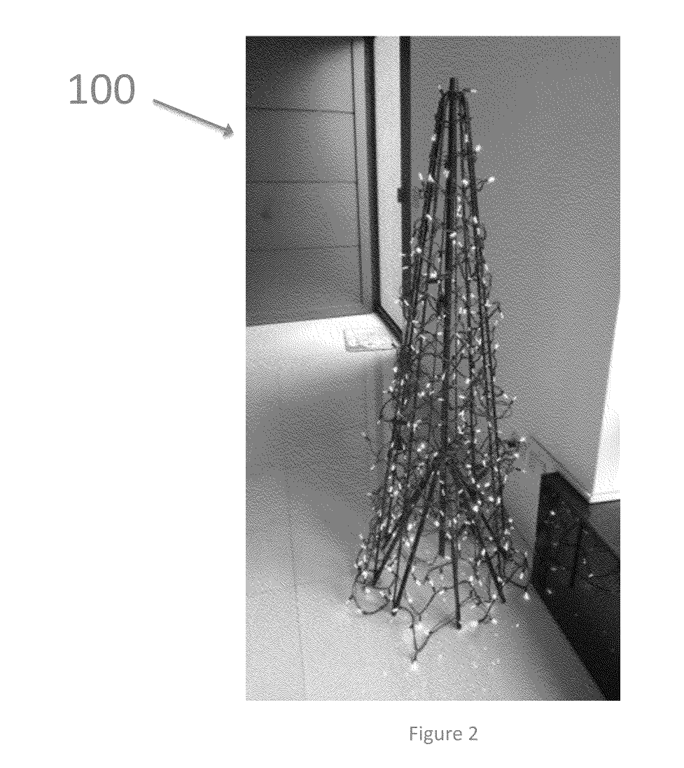

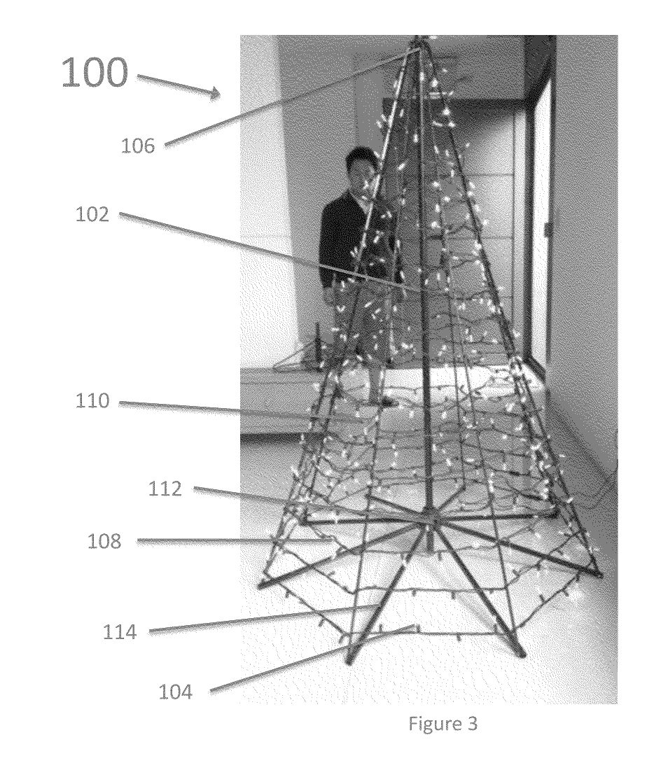

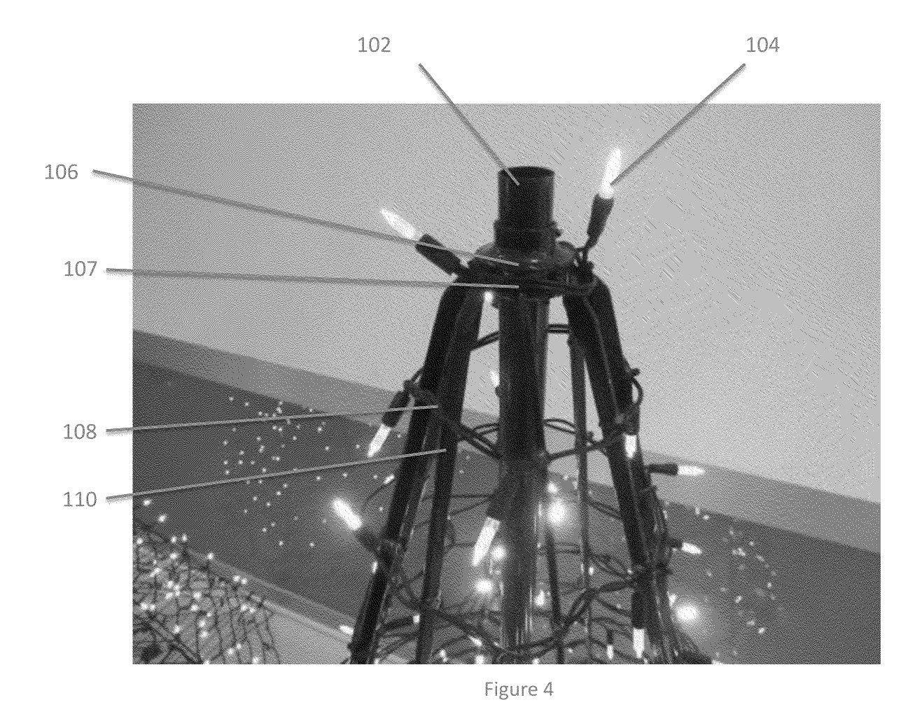

FIG. 1 shows an umbrella Christmas tree 100 in a storage position. In this position, the legs 114 of the tree are still able to support the tree so that it can stand upright. Therefore, the tree 100 can also be designed so that the tree is displayed when it the storage position. That is, the tree can resemble a cone with different radii at the bottom of the tree such that a tree with different girths can be displayed, and such that a continuum of display positions are possible. FIG. 2 shows that the tree can (but does not have to) be illuminated when in its storage position, and can be illuminated while transforming the tree between its storage and display positions. In order to stay in the storage position, the tree needs to be stable. This can be accomplished via a spring-biased protrusion which can extend from the tree trunk (similar to an umbrella), which can be released with the touch of a button located on the trunk 102 or slide ring 112 (discussed in further detail below), or the tree can comprise a memory or sensor that detects when the slide ring 112 is at a certain location on the tree trunk. For example, the slide ring can optionally lock when at its highest most position on the trunk when the tree is in the storage position, as well as when at its lowest most position on the trunk when the tree is in a display position. Hereby incorporated by reference is U.S. Pat. No. 7,322,371 to You, which provides a visual depiction of an example protrusion-based locking structure. In particular, refer to FIG. 3, protrusion 332 and apertures 334, 335 (also shown in other figures). A lock pin can also be used to stabilize the tree in the display positions. Alternatively, the slide ring may also be designed so that it is not per se locked, but rather is snugly and securely connected to the trunk and will move only when pressure is applied above a certain threshold, either in an upward or downward motion, by the assembler. The tree may also consist of a plug 120, which can plug into any electrical outlet providing the electricity needed to illuminate the tree. Although, the tree can also be battery powered, eliminating the need for an electrical plug.

FIG. 3 shows the umbrella tree in its display position, illuminated. The tree's main components include a trunk 102, a plurality of branches 110, a slide ring 112, a circular branch holder 106, electrical wiring 108, and legs 114. In the preferred embodiment, the trunk is cylindrical with a radius between 0.25″ and 0.5″, and extends from the top of the tree, through the circular branch holder 106 and slide ring 112, all the way to the floor. The tree can range in height, typically anywhere between 3 feet and 8 feet. A plurality of legs 114 are pivotably coupled to and housed within the grooves 116 of the slide ring 112. When the slide ring 112 travels upward in order to transform the tree into a storage position, the legs 114 pivot within the grooves 116 of the slide ring 112 such that the angle between the legs 114 and the trunk section beneath the slide ring 112 decreases, and likewise such that the angle between the legs 114 and the trunk section above the slide ring 112 increases. The tree 100 also comprises a plurality of branches 110, corresponding to the number of legs 114. As shown in FIG. 3, the tree comprises eight legs 114 and eight corresponding branches 110. When in a display position, a leg, a branch and the trunk form a scalene triangle, cross-sectionally across the height of one-half of the tree. In general, electrical wiring 108 surrounds the tree and comprises a plurality of light bulbs 104. In a preferred embodiment, and shown in FIG. 3, there are layers of wiring each forming an octagon outline around a cross-section of the width of the tree. Each layer is separated by about 8″ to 12″ along the height of the tree, resulting in approximately 16 layers of wiring total in the embodiment shown in FIG. 3. Light bulbs 104 are placed at intervals along the wire, typically at even spaced intervals but need not be. Light bulbs 104 are typically spaced at intervals of 8 inches. A key aspect of the invention is that the wiring and bulbs remain on the tree at all times, providing much needed convenience. Also, all of the various components of the tree 100 form a standalone unit, instead of comprising a set of detachable components. This way, components are never lost.

FIG. 4 shows a close-up view of the top of the umbrella tree 100. In the shown embodiment, the top of the trunk 102 extends beyond a circular branch holder 106. Each branch 110 is housed within and pivotably connected to the circular branch holder 106 via notches 107 that form part of the circular branch holder 106. Shown also are close-up views of the light bulbs 104 of the tree. The wiring 108, which forms an octagon outline at each width-wise cross-sectional layer of the tree, is of much smaller in radius at the top of the tree than at the bottom. When the tree is transformed into a display position, the angle between a branch 110 and top of the trunk 102 increases, and decreases when the tree is transformed into a storage position. In a preferred embodiment, the branches themselves can be rectangular or tubular. In the embodiment shown in FIG. 4, the branches 119 are rectangular with a width of about 0.25″. It is possible to insert/attach items into/to the top of the tree trunk, like an angel or star, similar to the way a typical Christmas tree would be decorated.

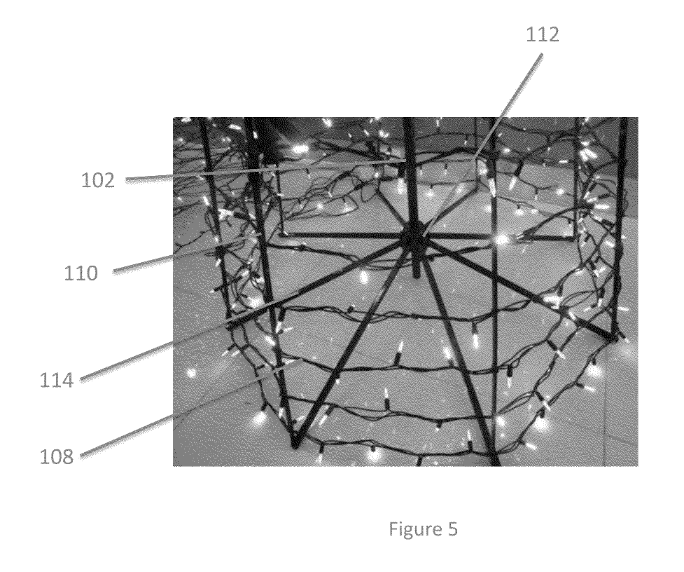

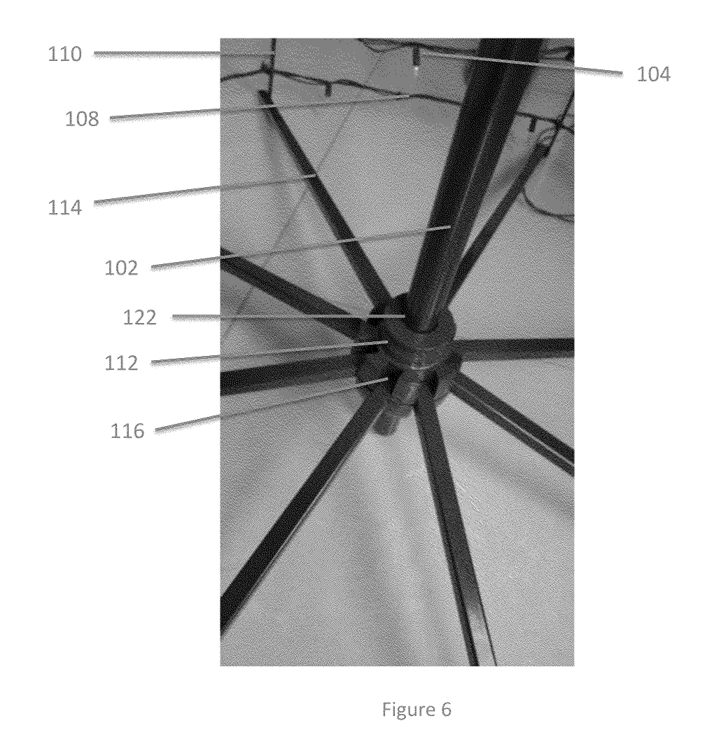

FIG. 5 shows a view of the bottom of the tree 100, when illuminated. As explained previously, the tree can remain lit while being transformed into the storage and display positions. FIG. 6 is another view of the bottom of the tree, viewing close-up the slide ring 112 and legs 114. The slide ring 112 is connected slidably to the trunk 102. Like the branches 110, the legs 114 are also shaped rectangularly. The legs 114 are larger in width so as to be able to support the tree in an upright position, typically with a width of approximately 0.5″. In the embodiment shown in FIG. 6, the slide ring comprises eight rectangularly shaped grooves 116 of corresponding width (0.5″), which pivotably connect the legs to the slide ring 112. In a typical embodiment, and as shown in FIG. 6, the slide ring 112 has a length of about 2 inches, and an overall diameter of approximately 2.5 inches. The slide ring 112 also comprises an aperture 122 with radius approximately 0.5″ into which the trunk 102 is inserted. The trunk passes throughout the length of the slide ring. Various mechanisms can be employed to enable the slide ring to slide along the trunk. For example, the slide ring may contain ball bearings, or springs/prongs of the requisite tension. In FIG. 6, the slide ring also comprises a concentric cylinder of slightly smaller diameter than the slide ring overall, which allows makes the leg grooves 116 of the slide ring 112 visible. In other embodiments the slide ring 112 can be of all one radius.

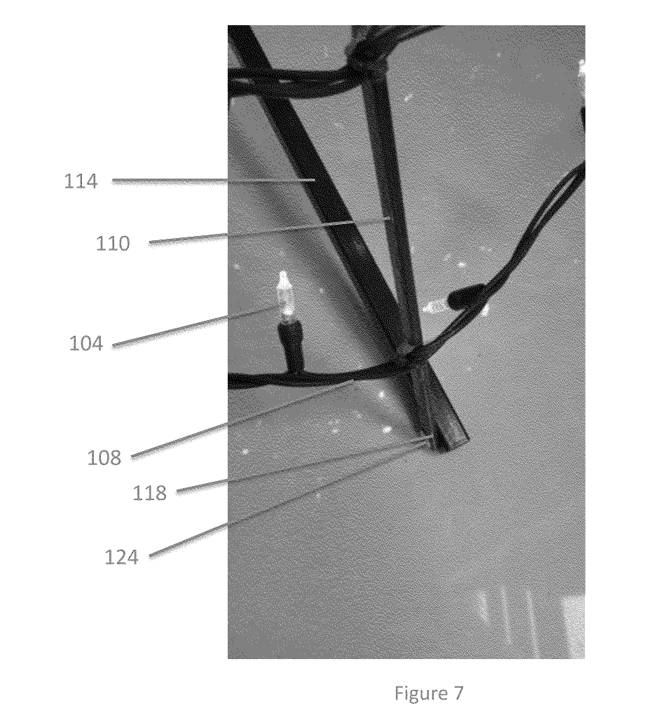

FIG. 7 is a close-up view of one of the branches 110 rotationally connected to one of the legs 114 at a leg-branch joint 118. A fastening unit 124 is used to rotationally connect the branch to the leg. The unit has a minute sized width so as to not protrude from the branch at the joint.

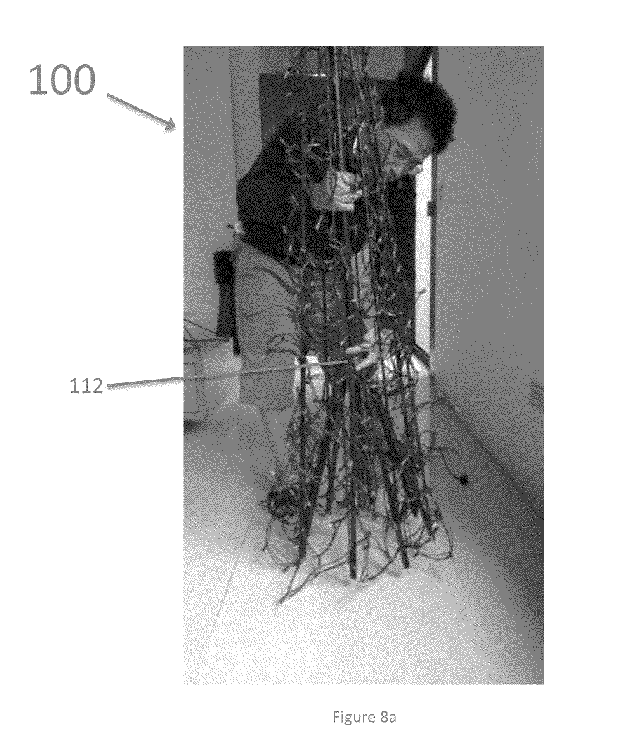

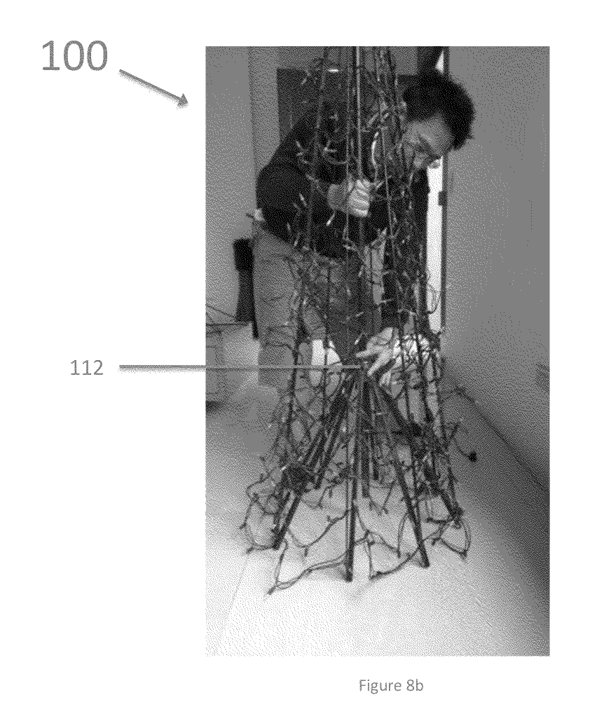

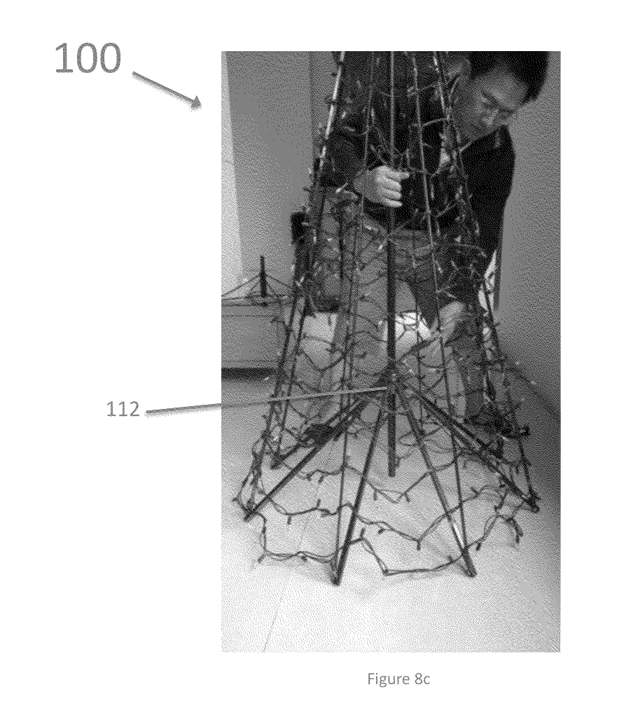

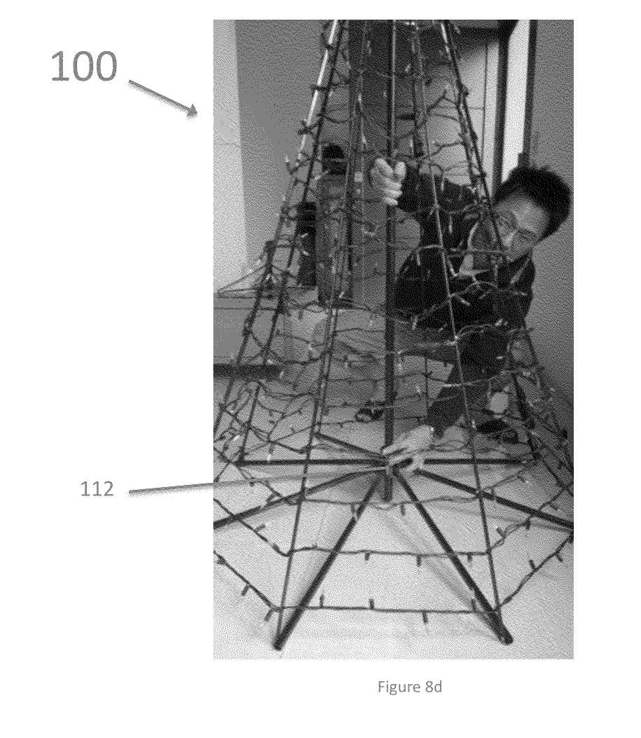

FIGS. 8a-8d show the umbrella tree 100 being assembled from a storage position to a display position. First the slide ring 112 is unlocked, or released, so as to be able to slide down the trunk. This is done either by pressing a spring release button (not shown) on the trunk or on the slide ring itself. The slide ring may also comprise a memory or sensor that detects that the assembler wishes to slide the slide ring. As previously mentioned when discussing FIG. 2, the slide ring may also be designed so that it is not per se locked, but rather is snugly connected to the trunk and will move only when pressure is applied above a certain threshold, either in an upward or downward motion, by the assembler. As the slide ring 112 is maneuvered down the trunk, the angle between the legs and the portion of the trunk above the slide ring (becoming larger) decreases, so that the legs fan out in a larger circle so as to be able to support the umbrella tree when it is in an upright position. Likewise, the angle between the legs and the portion of the trunk below the sling ring (becoming smaller) increases. This movement also makes the body of the tree fully developed. In FIG. 8d, the tree is in a complete display position, and the slide ring is locked at the bottom, or merely stable if not completely locked. The locking mechanism can be similar as the locking mechanism when the tree is in the storage position.

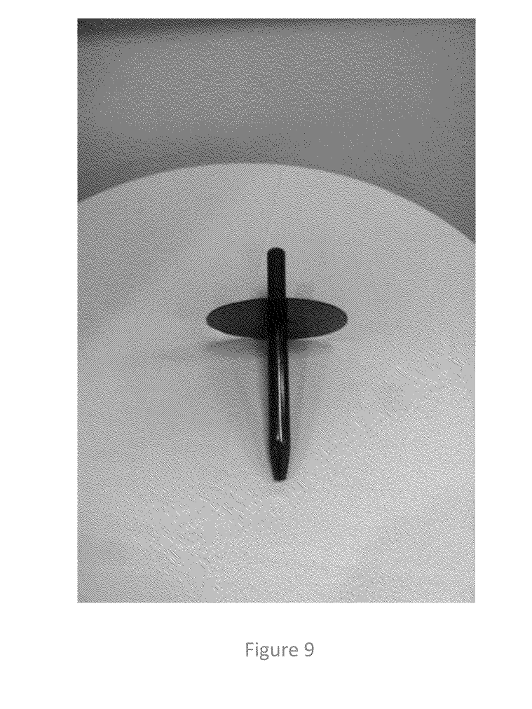

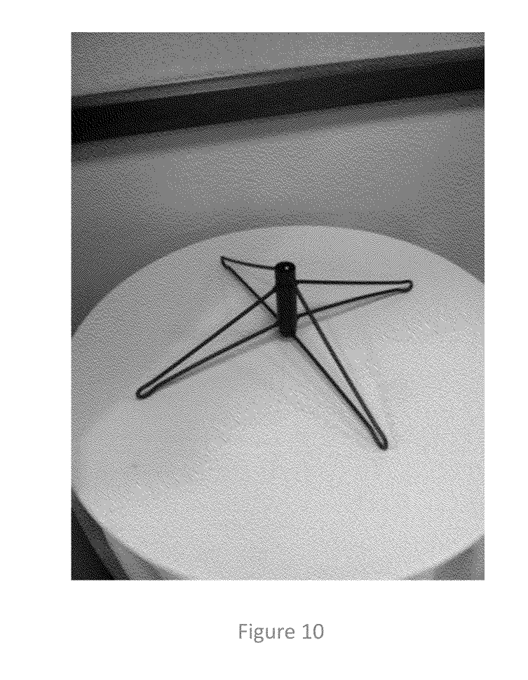

The tree is designed so that it can be displayed both outdoors and indoors. FIG. 9 is an example outdoor tree stand, an optional component of the tree, comprising a tubular core and circular support. The stand sticks into the ground. FIG. 10 is an example indoor tree stand, also an optional component of the tree when displayed. The indoor stand consists of four leg supports and a tubular base. Each leg support consists of two sub-supports forming a triangle with the tubular base.

The umbrella tree allows lights and other ornaments to be pre-decorated on the tree. The decorations do not have to be removed when taking the tree down, and therefore the tree does not have to be decorated when assembling the tree. Various ornaments and lights can be placed on the tree. Additionally, the trunk, branches, and legs can also be embellished, as they can also be capable of illumination, and can come in a variety of colors, not only green.

While the above specification and example provide a description of the invention, many embodiments of the invention can be made without departing from the spirit and scope of the invention. It is to be understood that the foregoing embodiment is provided as illustrative only, and does not limit or define the scope of the invention. Various other embodiments are also within the scope of the claims.

1. An artificial tree, comprising:
a trunk;
a branch holder;
a slide ring slidably connected to the trunk;
a plurality of branches directly and pivotably connected to the branch holder;
a plurality of legs, each leg separate from but corresponding to one of the plurality of branches and rotationally connected and fastened directly to said one branch, and pivotably connected to the slide ring;

3. The artificial tree of claim 1, wherein the branch holder comprises notches which directly and pivotably connect the plurality of branches to the branch holder.

4. The artificial tree of claim 1, wherein the decorative lights that may adorn the artificial tree do not need to be removed when transforming the tree from the storage position to a display position or vice versa.

9. The artificial tree of claim 1, further comprising fastening units, each of which rotationally connects one of the plurality of legs to one of the plurality of branches, whereby the one leg and one branch are separate.

1. An artificial tree, comprising:
a trunk;
a branch holder;
a slide ring slidably connected to the trunk;
a plurality of branches directly and pivotably connected to the branch holder;
a plurality of legs, each leg separate from but corresponding to one of the plurality of branches and rotationally connected and fastened directly to said one branch, and pivotably connected to the slide ring;
wherein the artificial tree can be transformed from a storage position to a display position and vice versa in one motion.

2. The artificial tree of claim 1, wherein the tree is transformed from the storage position to a display position by maneuvering the slide ring in one motion along the trunk of the tree, and wherein the tree is transformed from its display position into its storage position by maneuvering the slide ring in one motion in the opposite direction along the trunk of the tree.

3. The artificial tree of claim 1, wherein the branch holder comprises notches which directly and pivotably connect the plurality of branches to the branch holder.

4. The artificial tree of claim 1, wherein decorative lights that may adorn the artificial tree do not need to be removed when transforming the tree from the storage position to a display position or vice versa.

5. The artificial tree of claim 1, wherein the tree can stand upright and be displayed from either a display position or the storage position.

6. The artificial tree of claim 1, further comprising a first locking mechanism to prevent motion of the slide ring when the tree is in a display position, and a second locking mechanism to prevent motion of the slide ring when the tree is in the storage position.

7. The artificial tree of claim 6, wherein the locking mechanism includes a spring-biased protrusion extending from the trunk and fitting into or just outside the slide ring.

8. The artificial tree of claim 6, wherein the locking mechanism includes memory or sensors that detect when the slide ring is at a certain position on the trunk.

9. The artificial tree of claim 1, further comprising fastening units, each of which rotationally connects one of the plurality of legs to one of the plurality of branches, whereby the one leg and one branch are separate.

10. The artificial tree of claim 1, wherein the slide ring comprises grooves which house the legs and pivotably connect to legs to the slide ring.

11. (canceled)

12. The artificial tree of claim 1, wherein slide ring comprises means for allowing the slide ring to slide down the trunk, wherein said means can include ball bearings, spring-biased fittings, or pronged-biased fittings.

13. The artificial tree of claim 1, further comprising layers of electrical wiring in which each layer of wiring runs around the circumference of the width-wise cross-section of the artificial tree, spaced at various intervals along the height of the tree.

14. The artificial tree of claim 13, wherein the electrical wiring is adorned with light bulbs which electrically illuminate the tree, or ornaments which further embellish the tree.

15. The artificial tree of claim 13, further comprising means for illuminating the light bulbs, wherein said means can include a plug to be inserted into an electrical outlet, or a battery power source.

16. The artificial tree of claim 1, wherein the tree can be displayed of various girths, such that there is a continuum of display positions between the storage position and the maximum girth display position.

17. The artificial tree of claim 6, wherein the locking mechanism includes a pin which is inserted into an aperture located along the trunk.
